(19) United States
(12) Patent Application Publication
(10) Pub. No.: US 2010/0226460 A1
(43) Pub. Date: Sep. 9, 2010

(54) TUNER UNIT INCLUDING A PLURALITY OF TUNER CIRCUITS

(76) Inventor: Tsuyoshi ITAYA, Osaka (JP)

Correspondence Address: BIRCH STEWART KOLASCH & BIRCH, PO BOX 747, FALLS CHURCH, VA, 22040-0747, US

(21) Appl. No.: 12/690,534

(22) Filed: Jan. 20, 2010

(30) Foreign Application Priority Data
Mar. 5, 2009 (JP) 2009-051802(P)

(51) Int. Cl. H04L 27/00

(52) U.S. Cl. 375/316

(57) ABSTRACT

A tuner unit includes a case, first and second antenna terminals, a first tuner circuit for digital terrestrial broadcast reception, a second tuner circuit for digital satellite broadcast reception, and a plurality of external pins. The first and second antennal terminals are arranged in a line along a first straight line, and the plurality of external pins are arranged in a line along a second straight line parallel to the first straight line. A signal in the first tuner circuit flows in a direction from the first antenna terminal toward the second antenna terminal, and a signal in the second tuner circuit flows in a direction from the second antenna terminal toward the first antenna terminal. Consequently, reduction in size can be achieved while maintaining an interval between the first and second antenna terminals at a prescribed distance.

This nonprovisional application is based on Japanese Patent Application No. 2009-051802 filed on Mar. 5, 2009 with the Japan Patent Office, the entire contents of which are hereby incorporated by reference.

### BACKGROUND OF THE INVENTION

1. Field of the Invention

The present invention relates to a tuner unit, and more particularly to a tuner unit including a plurality of tuner circuits.

2. Description of the Background Art

Conventionally, there have been tuner units including both a tuner circuit for digital terrestrial broadcast reception and a tuner circuit for digital satellite broadcast reception (see Japanese Patent Laying-Open No. 5-260483 and Japanese Patent Laying-Open No. 2001-177424, for example).

FIGS. 9 and 10 show a schematic structure of such a tuner unit. In FIGS. 9 and 10, this tuner unit includes a rectangular plate-shaped case 51, two antenna terminals T1, T2, and a plurality of external pins P. Case 51 contains a substrate (not shown), on which surface a tuner circuit 52 for digital terrestrial broadcast reception and a tuner circuit 53 for digital satellite broadcast reception are mounted. Antenna terminals T1, T2 are provided on a surface of case 51 along one short side of the surface of case 51, and the plurality of external pins P are provided on an end surface of case 51 along one long side of the surface of case 51.

Tuner circuit 52 is driven by a power supply voltage and a control signal supplied from outside through the plurality of external pins P, and converts a high-frequency signal supplied from an antenna for digital terrestrial broadcast reception through antenna terminal T1 into an IF (Intermediate Frequency) signal. The IF signal is provided to the outside through external pins P.

Tuner circuit 53 is driven by a power supply voltage and a control signal supplied from outside through the plurality of external pins P, and converts a high-frequency signal supplied from an antenna for digital satellite broadcast reception through antenna terminal T2 into an IQ signal. The IQ signal is provided to the outside through external pins P.

In another tuner unit, antenna terminals T1, T2 are provided on an end surface of case 51 along one short side of the surface of case 51, as shown in FIG. 11.

In the two tuner units shown in FIGS. 9 to 11, antenna terminals T1, T2 are arranged in a line along a straight line A parallel to the short side of case 51, and the plurality of external pins P are arranged in a line along a straight line B parallel to the long side of case 51. Straight lines A and B are orthogonal to each other when viewed from above. Further, a direction C of a signal flow (direction of signal processing) in tuner circuit 52 and a direction D of a signal flow in tuner circuit 53 are the same direction (a direction in which the long side of case 51 extends).

In recent years, circuit integration of tuner circuits 52, 53 has progressed dramatically, which has led to significant reduction in space required for layout of tuner circuits 52, 53.

If the tuner units shown in FIGS. 9 to 11 are reduced in size with the same layout, however, an interval between two antenna terminals T1 and T2 decreases, resulting in difficulty in connecting an antenna wire to antenna terminals T1, T2. For this reason, there has been a limit to reduction in size of a tuner unit.

### SUMMARY OF THE INVENTION

Therefore, a main object of the present invention is to provide a small-sized tuner unit.

A tuner unit according to the present invention includes a substrate on which first and second tuner circuits for receiving first and second broadcasts, respectively, are mounted, a case containing the substrate, a first terminal provided on the case, for supplying a high-frequency signal from a first antenna to the first tuner circuit, a second terminal provided on the case, for supplying a high-frequency signal from a second antenna to the second tuner circuit, and a plurality of third terminals provided on the case, for supplying and receiving signals between outside and the first and second tuner circuits. The first and second terminals are arranged in a line along a first straight line, and the plurality of third terminals are arranged in a line along a second straight line parallel to the first straight line. A signal in the first tuner circuit flows in a direction from the first terminal toward the second terminal, and a signal in the second tuner circuit flows in a direction from the second terminal toward the first terminal.

Preferably, the first tuner circuit is arranged on one surface of the substrate, and the second tuner circuit is arranged on the other surface of the substrate.

Preferably, the first broadcast is a digital terrestrial broadcast, and the second broadcast is a digital satellite broadcast.

Preferably, the first tuner circuit outputs an IF signal, and the second tuner circuit outputs an IQ signal.

Preferably, the tuner unit further includes a demodulation circuit mounted on the substrate, for converting the IF signal and the IQ signal into a TS signal and outputting the TS signal to the plurality of third terminals.

In the tuner unit according to the present invention, the first and second terminals connected to the first and second antennas, respectively, are arranged in a line along the first straight line, the plurality of third terminals for supplying and receiving signals between outside and the first and second tuner circuits are arranged in a line along the second straight line parallel to the first straight line, a signal in the first tuner circuit flows in a direction from the first terminal toward the second terminal, and a signal in the second tuner circuit flows in a direction from the second terminal toward the first terminal. Consequently, a dimension of a device can be reduced while maintaining an interval between the first and second terminals at a prescribed distance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a schematic structure of a tuner unit according to an embodiment of the present invention.

FIG. 2 shows a signal flow in the tuner unit shown in FIG. 1.

FIGS. 3A and 3B illustrate an effect of the tuner unit shown in FIGS. 1 and 2.

FIG. 4 is a circuit block diagram showing a configuration of a tuner circuit for digital terrestrial broadcast reception shown in FIG. 2.

FIG. 5 is a circuit block diagram showing a configuration of a tuner circuit for digital satellite broadcast reception shown in FIG. 2.

FIG. 6 shows a modification of the embodiment.

FIG. 7 shows another modification of the embodiment.

FIG. 8 is a block diagram showing a configuration of a digital demodulation circuit portion shown in FIG. 7.

FIG. 9 shows a schematic structure of a conventional tuner unit.

FIG. 10 shows a signal flow in the conventional tuner unit shown in FIG. 9.

FIG. 11 shows a schematic structure of another conventional tuner unit.

### DESCRIPTION OF THE PREFERRED EMBODIMENTS

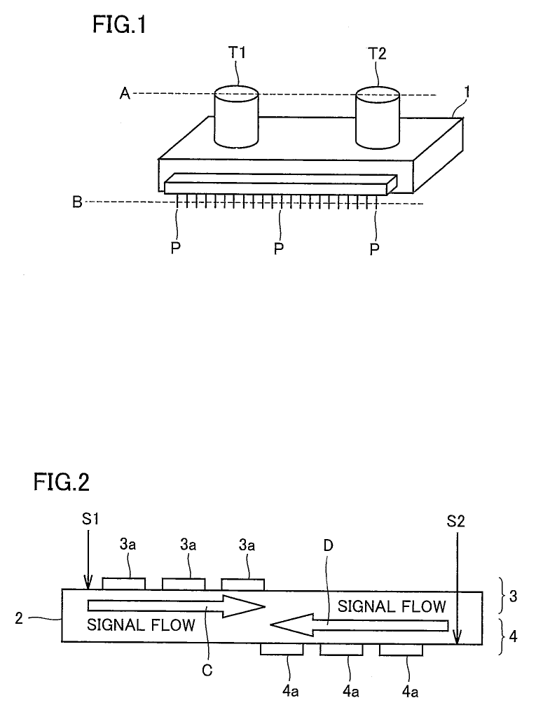

As shown in FIG. 1, this tuner unit includes a rectangular plate-shaped case 1, an antenna terminal (first terminal) T1, an antenna terminal (second terminal) T2, and a plurality of external pins (third terminals) P. Antenna terminal T1 is provided on a surface of case 1 in the vicinity of one short side, and antenna terminal T2 is provided on the surface of case 1 in the vicinity of the other short side. The plurality of external pins P are mounted on an end surface of case 1 along one long side of the surface of case 1. Further, case 1 contains a substrate 2, as shown in FIG. 2. A tuner circuit (first tuner circuit) 3 for digital terrestrial broadcast (first broadcast) reception including a plurality of electronic components 3a and the like is mounted on a surface side of substrate 2, and a tuner circuit (second tuner circuit) 4 for digital satellite broadcast (second broadcast) reception including a plurality of electronic components 4a and the like is mounted on a rear surface side of substrate 2.

Tuner circuit 3 is driven by a power supply voltage and a control signal supplied from outside through the plurality of external pins P, and converts a high-frequency signal S1 supplied from an antenna for digital terrestrial broadcast reception through antenna terminal T1 into an IF signal. The IF signal is provided to the outside through external pins P.

Tuner circuit 4 is driven by a power supply voltage and a control signal supplied from outside through the plurality of external pins P, and converts a high-frequency signal S2 supplied from an antenna for digital satellite broadcast reception through antenna terminal T2 into an IQ signal. The IQ signal is provided to the outside through external pins P.

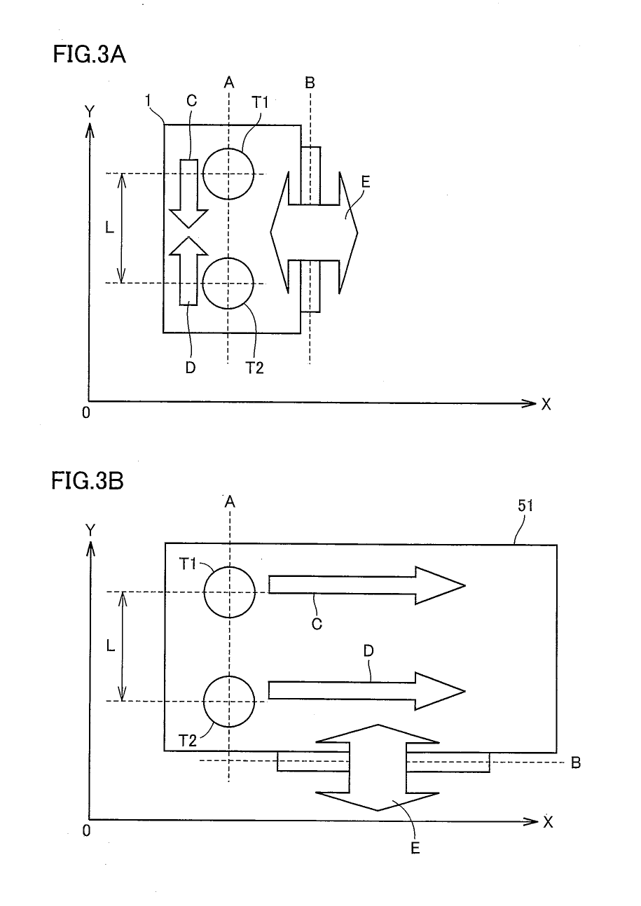

As shown in FIG. 3A, in the tuner unit according to this embodiment, antenna terminals T1, T2 are arranged in a line along a straight line (first straight line) A parallel to the long side of case 1, and the plurality of external pins P are arranged in a line along a straight line (second straight line) B parallel to the long side of case 1. Straight lines A and B are parallel to each other. A direction C of a signal flow (direction of signal processing) in tuner circuit 3 extends from antenna terminal T1 toward antenna terminal T2, and a direction D of a signal flow in tuner circuit 4 extends from antenna terminal T2 toward antenna terminal T1. A direction E in which signals are supplied and received between outside and tuner circuits 3, 4 is orthogonal to directions C, D of signal processing in tuner circuits 3, 4. With this layout, reduction in size of the tuner unit could be achieved while maintaining an interval between antenna terminals T1 and T2 at a prescribed distance L.

Preferably, signal output ends of tuner circuits 3, 4 are arranged in a portion intermediate between antenna terminals T1 and T2. Consequently, interference between tuner circuits 3 and 4 can be mitigated. In this case, both of tuner circuits 3 and 4 may be provided on the surface of substrate 2.

Alternatively, when tuner circuit 3 is provided on the surface of substrate 2 and tuner circuit 4 is provided on the rear surface of substrate 2 as shown in FIG. 2, the output ends of tuner circuits 3, 4 may overlap each other in a vertical direction. Moreover, by arranging a ground layer between tuner circuits 3 and 4, interference between tuner circuits 3 and 4 can be prevented while tuner circuits 3, 4 can also be overlapped with each other in a vertical direction, so that further reduction in size can be achieved.

As shown in FIG. 3B, in a conventional tuner unit, on the other hand, antenna terminals T1, T2 are arranged in a line along straight line A parallel to the short side of case 51, and the plurality of external pins P are arranged in a line along straight line B parallel to the long side of case 51. Straight lines A and B are orthogonal to each other. Directions C, D of a signal flow (directions of signal processing) in tuner circuits 52, 53 are the same as a direction in which the long side of case 51 extends. Direction E in which signals are supplied and received between outside and tuner circuits 52, 53 is orthogonal to directions C, D of signal processing in tuner circuits 3, 4. In the conventional tuner unit, a large area of case 51 was wasted, and thus reduction in size thereof could not be achieved.

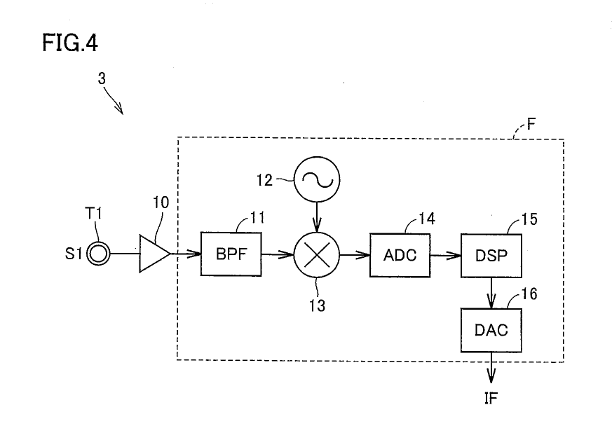

FIG. 4 is a circuit block diagram showing a configuration of tuner circuit 3 for digital terrestrial broadcast reception. In FIG. 4, tuner circuit 3 includes an RF amplifier 10, a band-pass filter (BPF) 11, a local oscillator circuit 12, a mixing circuit 13, an AD converter (ADC) 14, a DSP (Digital Signal Processor) 15, and a DA converter (DAC) 16.

High-frequency signal S1 received by the antenna for digital terrestrial broadcast reception is supplied to RF amplifier 10 through antenna terminal T1. RF amplifier 10 amplifies high-frequency signal S1. Band-pass filter 11 extracts a signal for a selected channel from amplified high-frequency signal 51. Local oscillator circuit 12 generates a local oscillation signal. Mixing circuit 13 mixes the signal for the selected channel with the local oscillation signal, and performs frequency conversion of the signal for the selected channel. An output signal from mixing circuit 13 is converted into a digital signal by AD converter 14, has its unnecessary signal components removed by DSP 15, and is further converted into an IF signal by DA converter 16. A circuit portion in tuner circuit 3 encircled by a dotted line F has been integrated, allowing layout in a very small space.

FIG. 5 is a circuit block diagram showing a configuration of tuner circuit 4 for digital satellite broadcast reception. In FIG. 5, tuner circuit 4 includes capacitors 20, 29, 34, a high-pass filter 21, RF amplifiers 22, 23, an AGC (Automatic Gain Control) amplifier 24, mixing circuits 25, 30, amplifiers 26, 28, 31, 33, 37, low-pass filters 27, 32, 43, an AGC circuit 35, a 90-degree shifter (phase-shift circuit) 36, a reference oscillator circuit 38, a VCO (Voltage Controlled Oscillator) 41, and a PLL (Phase Locked Loop) circuit 42.

High-frequency signal S2 received by the antenna for digital satellite broadcast reception is supplied to high-pass filter 21 through antenna terminal T2 and capacitor 20. High-pass filter 21 attenuates components having a prescribed frequency or a frequency lower than the prescribed frequency among frequency components of high-frequency signal S2.

RF amplifier 22 amplifies high-frequency signal S2 that has passed through high-pass filter 21. RF amplifier 23 amplifies an output signal from RF amplifier 22. AGC amplifier 24 amplifies an output signal from RF amplifier 23. AGC circuit 35 controls gain of AGC amplifier 24 based on an AGC signal AGC 1.

Mixing circuit 25 performs frequency conversion of high-frequency signal S2 to the IF signal by multiplying an output signal from AGC amplifier 24 by a first local oscillation signal received from 90-degree shifter 36, and outputs the resultant signal as an I signal. RF amplifier 26 amplifies the output signal from mixing circuit 25. Low-pass filter 27 attenuates components having a prescribed frequency or a frequency higher than the prescribed frequency among frequency components of an output signal from RF amplifier 26. RF amplifier 28 amplifies the I signal that has passed through low-pass filter 27, and outputs the resultant signal to the outside through capacitor 29.

Similarly, mixing circuit 30 performs frequency conversion of high-frequency signal S2 to the IF signal by multiplying the output signal from AGC amplifier 24 by a second local oscillation signal received from 90-degree shifter 36, and outputs the resultant signal as a Q signal. RF amplifier 31 amplifies the output signal from mixing circuit 30. Low-pass filter 32 attenuates components having a prescribed frequency or a frequency lower than the prescribed frequency among frequency components of an output signal from RF amplifier 31. RF amplifier 33 amplifies the Q signal that has passed through low-pass filter 32, and outputs the resultant signal to the outside through capacitor 34.

Reference oscillator circuit 38 includes a quartz resonator 39 and an oscillator 40, and outputs a reference signal. VCO 41 oscillates based on a control signal from PLL circuit 42 that has passed through low-pass filter 43 and the reference signal received from reference oscillator circuit 38, and outputs a local oscillation signal. Ninety-degree shifter 36 divides the local oscillation signal received from VCO 41 into the first and second local oscillation signals different in phase by 90 degrees, and outputs the resultant signals to mixing circuits 25, 30. Further, 90-degree shifter 36 outputs at least any one of the first and second local oscillation signals to amplifier 37. Amplifier 37 amplifies the local oscillation signal received from 90-degree shifter 36, and supplies the resultant signal to PLL circuit 42.

PLL circuit 42 generates the control signal based on PLL parameters included in external control signals SCL1, SDA1, and on the local oscillation signal received from amplifier 37, and outputs the control signal to low-pass filter 43. Low-pass filter 43 attenuates components having a prescribed frequency or a frequency higher than the prescribed frequency among frequency components of the control signal received from PLL circuit 42.

A portion encircled by a dotted line G in FIG. 5 has been integrated. A DC voltage VB2 is externally supplied to that integrated portion and RF amplifier 22. An externally supplied voltage VB1 is supplied to an LNB (Low Noise Block down converter) of the antenna for digital satellite broadcast reception. Capacitors 20, 29, 34 are provided in order to prevent effect of a DC voltage between a circuit in a preceding stage and a circuit in a subsequent stage.

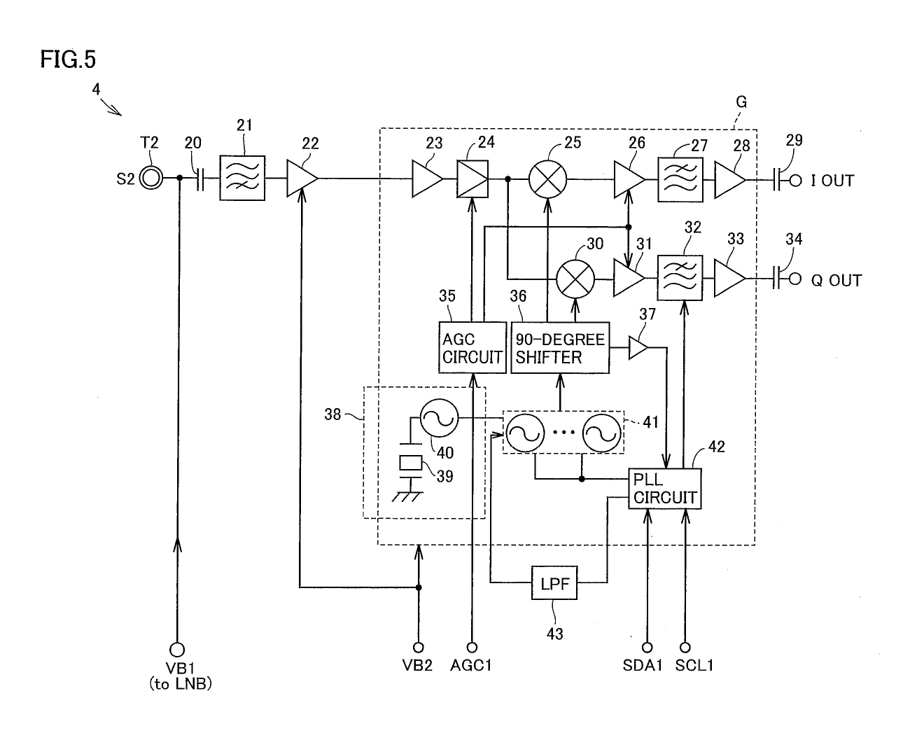

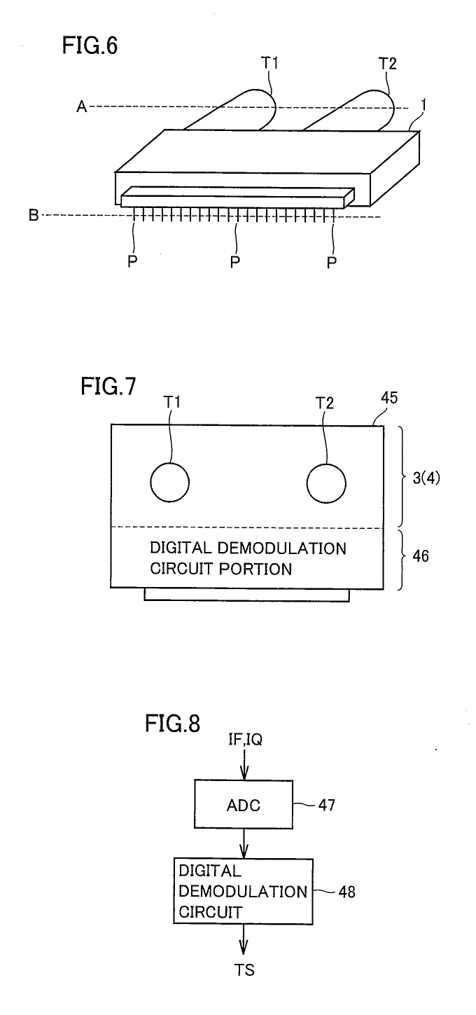

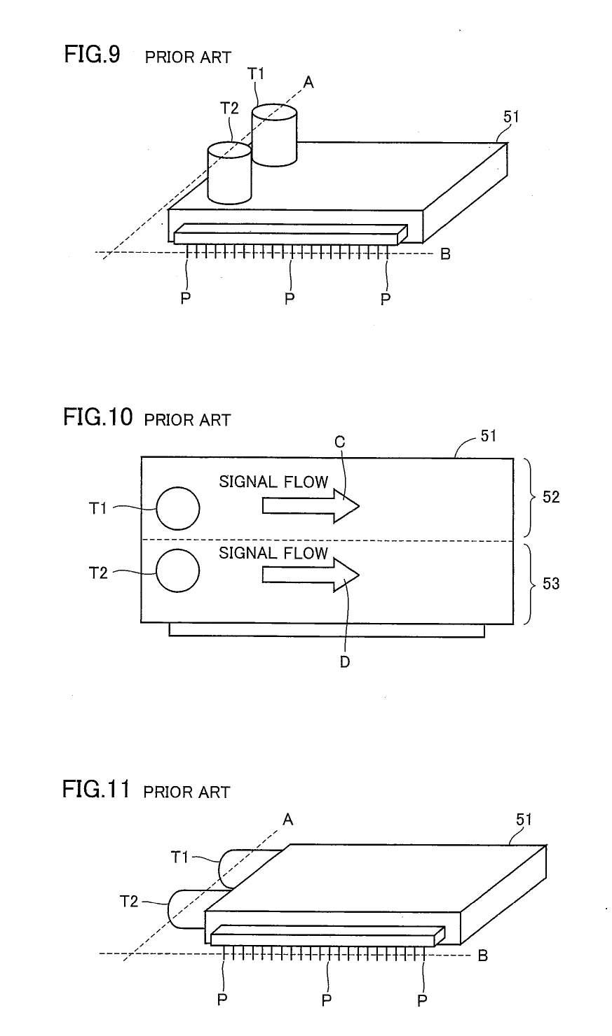

FIG. 6 shows a modification of this embodiment. In this modification, the plurality of external pins P are mounted on the end surface of case 1 along one long side of case 1, and antenna terminals T1, T2 are mounted on an end surface of case 1 along the other long side of case 1. The same effect as that of the embodiment can be achieved again in this modification.

FIG. 7 shows another modification of this embodiment. In this modification, antenna terminals T1, T2 and tuner circuits 3, 4 are arranged on one side of a case 45, and a digital demodulation circuit portion 46 is arranged between tuner circuits 3, 4 and the plurality of external pins P. Digital demodulation circuit portion 46 includes an AD converter 47 and a digital demodulation circuit 48, as shown in FIG. 8, and is mounted on a substrate the same as where tuner circuits 3, 4 are located. The IF signal and the IQ signal generated by tuner circuits 3, 4, respectively, are converted into digital signals by AD converter 47. The digital signal generated by AD converter 47 is converted into a TS (Transport Stream) signal by digital demodulation circuit 48. Consequently, a small-sized NWT (Network Interface Module) tuner set is implemented.

Although the present invention has been described and illustrated in detail, it will be clearly understood that the same is by way of illustration and example only and is not to be taken by way of limitation, the scope of the present invention being interpreted by the terms of the appended claims.

What is claimed is:

1. A tuner unit comprising:
a substrate on which a first tuner circuit and a second tuner circuit for receiving a first broadcast and a second broadcast, respectively, are mounted;
a case containing said substrate;
a first terminal provided on said case, for supplying a high-frequency signal from a first antenna to said first tuner circuit;
a second terminal provided on said case, for supplying a high-frequency signal from a second antenna to said second tuner circuit; and
a plurality of third terminals provided on said case, for supplying and receiving signals between outside and said first and second tuner circuits,
said first and second terminals being arranged in a line along a first straight line,
said plurality of third terminals being arranged in a line along a second straight line parallel to said first straight line, and
a signal in said first tuner circuit flowing in a direction from said first terminal toward said second terminal, and a signal in said second tuner circuit flowing in a direction from said second terminal toward said first terminal.

2. The tuner unit according to claim 1, wherein
said first tuner circuit is arranged on one surface of said substrate, and
said second tuner circuit is arranged on the other surface of said substrate.

3. The tuner unit according to claim 1, wherein
said first broadcast is a digital terrestrial broadcast, and
said second broadcast is a digital satellite broadcast.

4. The tuner unit according to claim 3, wherein
said first tuner circuit outputs an IF signal, and
said second tuner circuit outputs an IQ signal.

5. The tuner unit according to claim 4, further comprising:
a demodulation circuit mounted on said substrate, for converting said IF signal and said IQ signal into a TS signal and outputting the TS signal to said plurality of third terminals.
